(19) United States
(12) Patent Application Publication
(10) Pub. No.: US 2008/0222662 A1
(43) Pub. Date: Sep. 11, 2008

(54) Method for testing device descriptions for field devices of automation technology

(75) Inventor: Michael Gunzert, Herxheim (DE)

Correspondence Address: BACON & THOMAS, PLLC, 625 SLATERS LANE, FOURTH FLOOR, ALEXANDRIA, VA, 22314-1176, US

(73) Assignee: CodeWrights GmbH, Karlsruhe (DE)

(21) Appl. No.: 12/003,104

(22) Filed: Dec. 20, 2007

(30) Foreign Application Priority Data
Dec. 29, 2006 (DE) 10 2006 062 604.4

(51) Int. Cl. G06F 9/46

(52) U.S. Cl. 719/321

(57) ABSTRACT

A method for testing device descriptions for field devices of automation technology, which are executed in a frame application running on a computer unit, provides, between the frame application and the device descriptions, a test component, which, on the one hand, is transparent for the communication between the frame application and the device descriptions, and which, on the other hand, tests interface invocations according to a predetermined specification.

### TECHNICAL FIELD

The invention relates to a method for testing device descriptions for field devices of automation technology, as such which are executed in a frame application running on a computer unit, where the device description and the frame application communicate via an interface defined in a specification.

### BACKGROUND DISCUSSION

Field devices are commonly employed in automation technology (process automation/manufacturing automation) and serve for registering and/or influencing process variables. Examples of such field devices are fill level measuring devices, mass flow measuring devices, pressure- and temperature-measuring devices, pH- and redox-potential-measuring devices, conductivity measuring devices, etc. for process automation technology, which, as sensors, register the corresponding process variables, fill level, flow, e.g. flow rate, pressure, temperature, pH-value and conductivity value, respectively.

Serving for influencing process variables are actuators, e.g. valves, which control flow of a liquid in a section of pipeline, or pumps, which change fill level in a container.

A large number of such field devices are manufactured and sold by the firm ENDRESS+HAUSER®.

Frequently, field devices are connected with superordinated units via communication systems (PROFIBUS®, FOUNDATION-FIELDBUS®, HART®, etc.). Such superordinated units serve for process control, process visualization, device-management (configuration and servicing) and for plant management (asset management), using corresponding application programs.

The integration of field devices into such applications occurs via device descriptions. Device descriptions are provided by device manufacturers, in order that superordinated units can recognize and interpret the meaning of data supplied by the field devices.

Various device descriptions are known for the different fieldbus systems (HART-device-descriptions, Fieldbus Foundation device descriptions, Profibus device descriptions).

On the basis of cooperation of Fieldbus Foundation (FF), HART Communication Foundation (HCF) and Profibus Nutzerorganisation (PNO), an electronic device description (Electronic Device Description EDD) was created, which is defined in the standard IEC 61804-2.

With a large number of EDD-based fieldbus systems installed worldwide, EDD is a very widely used description language for device descriptions in automation technology.

For servicing field devices, corresponding servicing programs (operating tools) are necessary, which, in superordinated units, run either on their own (Endress+Hauser FieldCare, Pactware, AMS Fisher-Rosemount, PDM Siemens) or else are integrated into control system applications (Siemens PCS7, ABB Symphony, Emerson Delta V).

For a comprehensive servicing of field devices, newly, special device descriptions, so-called DTMs (Device Type Manager), are available, which correspond to the FDT (Field Device Tool) specifications. The FDT-specifications, serving as an industry standard, were developed by the PNO (Profibus Nutzer Organisation (Profibus User Organization)) in cooperation with ZVEI (Zentralverband Elektrotechnik-und Elektroindustrie (The German Electrical and Electronics Industry, a registered association)). The current FDT-Specification 1.2.1, including the Addendum for “Foundation Fieldbus” Communication, is available from ZVEI, PNO or the FDT-Group.

Many field device manufacturers already deliver corresponding DTMs for their field devices. The DTMs encapsulate all variables and functions of the pertinent field device and offer, most often, a graphical user interface for servicing the devices.

As run-time environment, the DTMs require a frame application (FDT-frame). The frame application and the corresponding DTMs permit, thus, a very comfortable access to field devices (e.g. to device parameters, measured values, diagnostic information, status information, etc.), as well as serving for invoking special functions, which individual DTMs make available.

Since field devices are serviced via DTMs, extensive function tests are needed, in order to assure that the DTMs work faultlessly in any and all frame applications. These function tests have also a safety aspect, since especially safety-critical settings can be made in field devices via DTMs.

One possibility for testing DTMs is offered by the test tool dtmINSPECTOR (M&M Software GmbH, St. Georgen). In such instance, extensive test scripts are produced, which are executed together with the DTM to be tested. Essentially, this test checks whether the DTM corresponds to the FDT-specifications (FDT interface definitions). With this test tool, in principle, it is a review only of whether the interface is working logically faultlessly. Even in the case of a successfully passed test with the help of this test tool, it is, however, not assured that the DTM will function faultlessly in all frame applications, since the sequence of the interface invocations can be different from frame application to frame application, a fact which can lead to different outcomes.

It is, therefore, necessary to test DTMs in different frame applications and, in such case, to check whether DTM and frame application each behaves correctly in the sense of the specification.

The applicant (Codewrights GmbH Karlsruhe) prepares from conventional device description files (HART, FF or Profibus), with the help of a corresponding tool (DTMstudio), device-specific DTMs in large quantities. To test the faultless functioning of each separate DTM would mean a significant test effort. But, even such extensive testing can not uncover all errors with certainty.

Moreover, there is the problem, that, in the case of malfunction, it is not at first clear, which component (DTM or frame application) is causing the error. Due to the very complex interaction between the individual components, the error analysis is often very complex and time-intensive, which, unavoidably, is associated with significant costs.

### SUMMARY OF THE INVENTION

An object of the invention is, therefore, to provide a method for testing device descriptions for field devices of automation technology, which method does not have the aforementioned disadvantages, while, especially, requiring less testing effort.

This object is achieved by the provision between the frame application and the device descriptions, a first component which is transparent for the communication between frame application and device descriptions and which reviews interface invocations.

An essential idea of the invention is to provide, between frame application and device description, a test component, which is transparent for the communication between frame application and device description and which checks interface invocations for conformity with the specification.

In such case, both the device description (DTM) and also the frame application are checked for conformity.

In a further development of the invention, it is checked, whether the interface invocations are allowed according to the specification. Moreover, it is checked, whether the data transferred in the case of an interface invocation correspond to the specification.

Frequently, sequences of interface invocations are specified in interface specifications for certain tasks (e.g. storage on demand of the frame application). Therefore, in a further development of the invention, it is also checked, whether sequences of interface invocations correspond to the specifications.

In an advantageous manner, the test component is described with the help of state automata, which represent the dynamic course of events possible in the framework of the specification.

The method of the invention is suited especially for device descriptions, which, as DTMs, correspond to the FDT-specifications.

### BRIEF DESCRIPTION OF THE DRAWING

The invention will now be explained in greater detail on the basis of an example of an embodiment presented in the drawing.

FIG. 1 illustrates the basic structure of a frame application and a plurality of device managers according to the FDT-concept.

### DETAILED DESCRIPTION

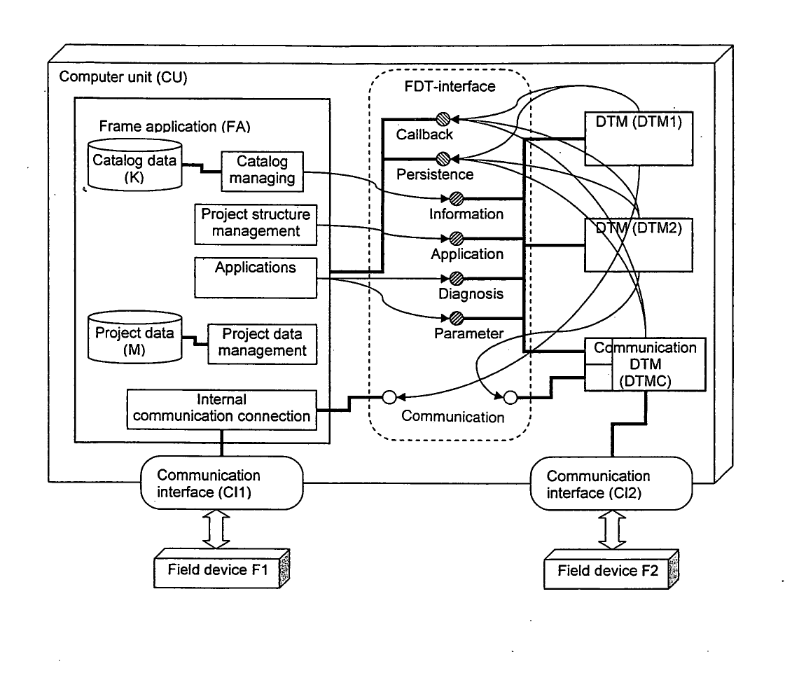

FIG. 1 shows, schematically, the basic structure of the FDT-concept. A frame application FA, which runs on a computer unit CU, communicates via defined FDT-interfaces FDT with device manager instances DTM1, DTM2, which enable a comprehensive servicing of the field device types associated with the respective device managers. The frame application FA also communicates with the communication manager instance DTMC, which enables a comprehensive servicing of the interface. The frame application FA can be, for example, the product FieldCare® of the firm, Endress+Hauser. Frame application FA serves for, among other things, managing and instantiating various objects; in such case, the frame application is responsible for building the project structure, establishing connections between device- and communication-manager-instances, starting and managing applications, storing and loading project data, as well as production and destruction of projects.

For managing the project structure, each device manager and communication manager offers information via its Information interface. On the basis of this information, the frame application FA can accumulate catalog data K needed for managing the project structure. With the project structure, the frame application controls and manages also the communication paths. FIG. 1 shows two communication networks (e.g. fieldbuses), which are accessed via communication interfaces CI1, CI2. The device manager instances do not communicate with the field devices directly, but, instead, utilize the communication interface of FDT, which can be offered both by the frame application FA and also by a communication-manager instance. In FIG. 1, the device manager instance DTM1 communicates via a communication interface CI1 in the frame application FA with the field device F1 associated therewith, while the device manager instance DTM2 communicates with the field device F2 with the help of the communication-manager instance DTMC via a communication interface CI2. Frame application FA manages applications, which are part of the frame application, as well as also managing device manager- and communication manager-specific applications. Internal applications of the frame application FA, such as diagnostic methods and data registering, use the FDT interfaces for exchanging data with the device- and communication-manager-instances. Device manager- and communication manager-specific applications are managed by the frame application by means of an Application interface. The frame application queries, for this purpose, via an Information interface, type and number of the available applications.

The persistence of the project data is implemented by the frame application FA with the help of a Persistence interface, which are served by the device- and communication-manager instances.

Frame application FA forms, together with the device manager instances DTM1, DTM 2 and the communication manager instance DTMC, etc., an object-based configuration system CS for field devices of automation technology.

As already mentioned, the field device manufacturers make device managers available for their individual field devices. Before a field device can be accessed, the corresponding device manager, with all belonging objects, must be instantiated.

According to the invention, provided between the frame application FA and the DTMs is a test component P, which is transparent for the communication via the FDT interface between frame application and each DTM and which reviews the interface invocations.

Thus, with the help of the test component P, it is checked whether the interface invocations are even permitted by the FDT specifications.

Additionally, it can be checked with the test component P, whether the data transferred in the case of an interface invocation correspond to the FDT specifications.

With the test component P, it is also possible to check sequences of interface invocations for conformity with the FDT specifications.

From the specifications and the allowed chains of events at the interfaces, a formal model, a state automaton, is generated, on which the test component is essentially based.

With the present invention, it is possible to check for the correct interplay between a device description DTM and a frame application FA. This can be done without additional effort during the integration test, which usually must be performed. Behavior of one of the two components not conforming to specification is immediately recognized, even when this does not immediately lead to a malfunction of the total system.

In a further development of the invention, it is also possible to check all components of a more complex system having a plurality of DTMs (communication-, gateway- and device-DTMs).

The invention checks not only the logical function of the DTM interface but also the actual, concrete interplay of frame application and DTM.

1-7. (canceled)

8. A method for testing device descriptions for field devices of automation technology, which are executed in a frame application running on a computer unit, comprising the steps of:
providing an interface for the communication of the interface being device descriptions and the frame application defined in a specification; and
providing between the frame application and the device descriptions, a test component, which is transparent for the communication between frame application and device descriptions and which reviews interface invocations.

9. The method as claimed in claim 8, further comprising the step of:
checking whether interface invocations are allowed according to the specification.

10. The method as claimed in claim 8, further comprising the step of:
checking whether data transferred during interface invocations correspond to the specification.

11. The method as claimed in claim 8, further comprising the step of:
checking a sequence of interface invocations for conformity with the specification.

12. The method as claimed in claim 8, wherein:
the test component is based on a state automaton, which describes the specification and the allowed chains of events at the interfaces.

13. The method as claimed in claim 8, wherein:
the device description is a DTM and the interfaces meet the FDT specifications.

14. The method as claimed in claim 8, wherein:
a system having a plurality of components (frame application, device descriptions, communication- and gateway-components), which interact with one another, each individual component is checked for correct behavior with reference to the specification.
